(19) United States
(12) Patent Application Publication
(10) Pub. No.: US 2006/0294557 A1
(43) Pub. Date: Dec. 28, 2006

(54) Presentation of information relating to change of a programming state

(75) Inventors: Ronald Alan Morris, San Francisco, CA (US); David Sloo, Menlo Park, CA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/165,754

(22) Filed: Jun. 23, 2005

(51) Int. Cl. H04N 7/173

(52) U.S. Cl. 725/89; 725/88; 725/102; 725/134

(57) ABSTRACT

A system coupled to a presentation device, such as, for example, a television or audio speaker. The system receives a selection of a program for presentation to a user of the system. The system provides information, including, for example, a sound or displayed icon, to indicate to the user that, if the user transitions away from the program, the user will be able to transition at a later time to presentation of the program.

### BACKGROUND

Current advanced television systems allow a user to view and/or listen to programs that are broadcast live, are supplied in an on-demand fashion, or are otherwise stored for later playback. These programs can take many forms, including movies, television shows, interactive games, digital photo albums and music content.

Because programs are typically digitally formatted, advanced television systems often enable a user to pause the play or playback of a program. For example, in certain digital television systems, a program can be automatically paused as a user tunes or otherwise transitions away from it, enabling the user to resume subsequent play of the program from the position in the program at the time of tuning away. However, the inventors have observed that many users are reluctant to tune away from programs, in particular (but not only) on-demand or live programs, for example, out of concern that their position in the program, or the program itself, may be irretrievably lost.

### SUMMARY

This Summary is provided to generally introduce to the reader, in simplified form, one or more select concepts described below in the Detailed Description. This Summary is not intended to identify key and/or required features of the claimed subject matter, nor is it intended to be used as an aid in determining the scope of the claimed subject matter.

An embodiment discussed herein provides a system coupled to a presentation device, such as, for example, a television or audio speaker. The system receives a selection of a program for presentation to a user of the system. The system provides information, including, for example, a sound or displayed icon, to indicate to the user that, if the user transitions away from the program, the user will be able to transition at a later time to presentation of the program.

An embodiment discussed herein further provides a system coupled to a display device with which video programming can be displayed. The system presents to a user of the system a program. Upon receiving an instruction to present content other than the program, the system presents the content. While presenting the content, the system informs the user about the status of the program presentation (e.g., that the program has been paused).

### BRIEF DESCRIPTION OF THE DRAWINGS

FIG. 1 is a schematic diagram of an illustrative interactive media system in which embodiments may be implemented;

FIG. 2 is a screen display illustrating operational features according to an embodiment;

FIGS. 3A and 3B are screen displays illustrating operational features according to an alternative embodiment;

FIG. 4 is a screen display illustrating operational features according to an alternative embodiment;

FIG. 5 is a flow diagram of a method according to an embodiment;

FIG. 6 is a flow diagram of a method according to an alternative embodiment; and

FIG. 7 is a flow diagram of a method according to an alternative embodiment.

Like reference numerals are used to designate like parts in the accompanying Drawings.

### DETAILED DESCRIPTION

Previously, it has not been appreciated that a user may not transition away from a media program because the user may not know that transitioning away from (or back to) the media program will pause (or unpause) the media program. It has also not been appreciated that a transition-pause effect may be counterintuitive or unexpected. It has been further unappreciated that as a consequence a user often does not take advantage of a transition-pause effect and instead will continue playing a same media program when in fact the user would prefer to perhaps temporarily select another media program.

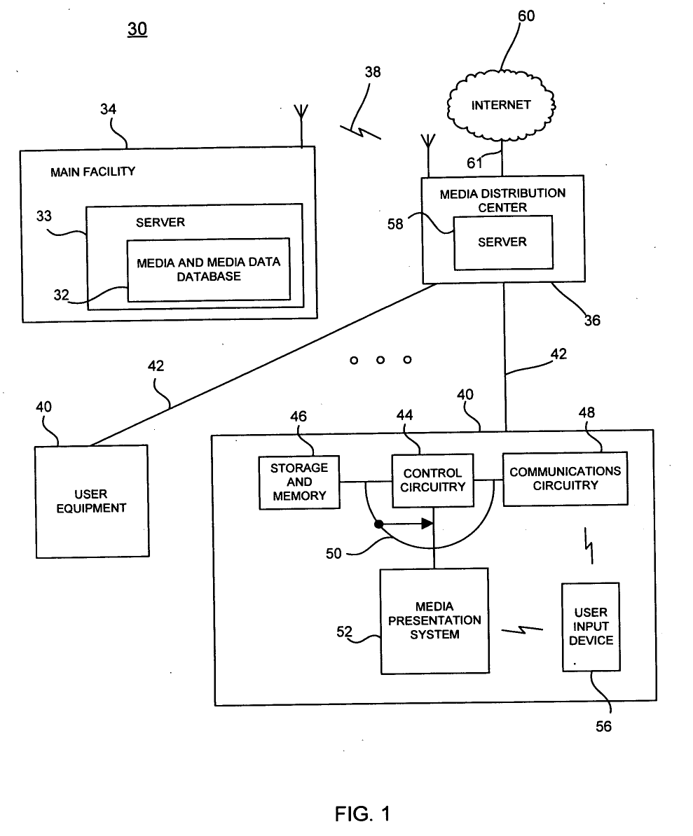

FIG. 1 illustrates an interactive media system 30 in which one or more embodiments may be implemented. The components of the interactive media system 30 described herein are exemplary and are not intended to suggest any limitation as to the scope of use or functionality of embodiments. The described embodiments should not be interpreted as having any particular dependency or requirement relating to any one component or combination of components illustrated in and described with reference to FIG. 1.

The interactive media system 30 may include a main facility 34, a media distribution facility 36, and user equipment 40, including one or more client devices. Although only one main facility 34 is illustrated in FIG. 1, the interactive media system 30 may include multiple main facilities. For clarity, embodiments will be discussed in connection with the use of one such main facility. The main facility 34 may include a server 33 for storing and distributing media programs and associated media data. The server may have a database 32 for storing the media programs and media data.

Media programs may be in the form of audio and video media such as broadcast television programs, cable television programs, pay-per-view programs, video-on-demand (VOD) programs, near video-on-demand (NVOD) programs, available-on-demand applications (e.g., on-demand interactive games), music, promotional material, or any other type of deliverable media. In the described exemplary implementations, the media programs may be associated with traditional broadcast channels (which are tuned by frequency), with Internet Protocol TV broadcast channels (which are tuned by uniform resource locator), and/or with any other types of channels over which media content may be transmitted. Media data may include data associated with the media programs, such as metadata, identifiers, universal resource locators, interactive media application control information, program guide information (e.g., program guide listings data, pay-per-view ordering information, program promotional information, or any other suitable program guide information) or any other deliverable data.

Main facility 34 may distribute the media programs and media data to multiple media distribution facilities 36 via communications paths such as communications path 38. Communications path 38 may be any suitable communications path, such as a satellite link, a cable link, a fiber-optic link, a microwave link, a telephone network link, an Internet link, or a combination of such links. Although only one distribution facility 36 is illustrated in FIG. 1, the interactive media system 30 may include multiple distribution facilities. For simplicity, the embodiments will be discussed in connection with the use of one such distribution facility.

Media distribution facility 36 may be a broadcast television facility, a cable system headend, a satellite distribution facility, a broadcast music facility, or any other suitable media distribution facility for transmitting media programs and other information to user equipment 40. Media distribution facility 36 may include a server 58. Server 58 may be capable of handling media such as text, images, graphics, audio, video, any other suitable media, or a combination of such media. Server 58 may include a database for storing media programs, media data or any other suitable content. In addition, server 58 may be capable of providing interactive services such as NVOD and VOD. Server 58 may be based on one or more computers. Media distribution facility 36 may distribute various media programs to user equipment 40 over communications paths 42, which may be unidirectional or bidirectional.

Each media distribution facility 36 may have a number of associated users, each of which may have user equipment 40 coupled to the media distribution facility via one of communications paths 42. User equipment 40 may be equipment such as user television equipment, user computer equipment (e.g., a desktop computer, a laptop computer, a notebook computer, a handheld computing device such as a personal digital assistant or other small portable computer, etc.), user music equipment (e.g., a stereo receiver or satellite radio receiver) or any other suitable user media equipment for presenting media programs and/or executing an application, such as an interactive media application. An interactive media application may be implemented locally on user equipment 40 or may be implemented using a client-server or distributed architecture where some of the application is implemented locally on user equipment 40 in the form of a client process and some of the application is implemented at a remote location (e.g., media distribution facility 36) as a server process.

User equipment 40 may include components, such as control circuitry 44, storage and memory 46, communication circuitry 48, media presentation system 52, and user input device 56, for presenting media programs and/or implementing an interactive media application. The control circuitry 44, storage and memory 46, and communication circuitry 48 may be combined to form a conventional client device, such as, for example, a set-top box. The components may be configured to support functions of the interactive media application such as receiving media programs and media data, recording media programs to storage and memory 46, simultaneously recording and playing media programs, playing recorded media programs from storage, and sending and receiving application data and information. Control circuitry 44 may communicate with and control storage and memory 46, communications circuitry 48, and media presentation system 52 using communications paths 50. Communications paths 50 may be hard-wired, wireless (e.g., Bluetooth), optical paths or the like.

Storage and memory 46 may include a magnetic media recorder (e.g., hard disk drive or the like), memory (e.g. flash memory, EEPROM, or the like), a videocassette recorder, a digital recording device, any other suitable memory and storage device, or any suitable combination thereof. Some or all of storage and memory 46 may be located external to a device that contains control circuitry 44.

Control circuitry 44 may provide media presentation system 52 with media program content stored in storage and memory 46. Control circuitry 44 may also provide media presentation system 52 with media program content that is received from communications circuitry 48. Media presentation system 52 may include a television, a computer system with monitor and speakers, a stereo system, any other suitable presentation device, or any combination thereof.

The user may interact with control circuitry 44 using input device 56. User input device 56 may include a remote control, a keyboard, a wireless keyboard, a display remote, a handheld computer, a mouse, a trackball, a touch pad, or any other suitable interactive interface. User input device 56 may transmit signals to communications circuitry 48 or media presentation system 52 via any suitable communications path, such as a hard-wired or wireless path.

The features of embodiments of the present invention may be described herein in the context of an interactive media application implemented on user television equipment. This is only illustrative. An interactive media application implemented on any suitable platform (user computer equipment, user music equipment, or any other suitable platform) may be used to provide described features, such as generating informational messages and icons to a screen or audio speaker.

In an embodiment, the interactive media application may provide the user with access to real-time media programs. The real-time media programs may, for example, be television programming, music programming, interactive gaming programming or any other suitable media. The real-time media programs may be presented to the user on media presentation system 52. The interactive media application may provide the user with the ability to pause the real-time media programs. This may be done, for example, by pressing a pause button on a remote control. In response to the pause command, the interactive media application may direct the real-time media program to be stored at user equipment 40 (e.g., in storage and memory 46). In another suitable approach, the interactive media application may direct the real-time media program to be stored on a remote server. The remote server may be located at distribution facility 36, at a storage facility accessible via the Internet, or at any other suitable remote location. The real-time media program may be stored from substantially the same point in time as the issuance of the pause command and onwards. In another suitable approach, the real-time media program may begin being stored shortly after the time of issuance of the pause command. While the real-time media program is paused, the interactive media application may present information to the user.

In another suitable approach, the interactive media application may continuously store the real-time media program that the user is playing. The interactive media application may, for example, store the previous half hour or any other suitable time period of media that has been played. In this embodiment, the real-time media program being played is retrieved from local storage. The real-time media program may be played at substantially the same time at which user equipment 40 receives the real-time media program. The interactive media application in this embodiment may enable the user to rewind, pause, and fast-forward the real-time media program.

The interactive media application may also display information on user equipment 40, for example, in the form of an overlay, an interactive overlay, a program guide screen, or in any other suitable display format. The interactive media application may display information to inform the user as to the status of the interactive media application or media program, or in response to user inputs (e.g., play, pause, fast-forward, rewind, stop, etc.). This displayed information may be displayed for a certain period of time and then time out or may be removed in response to a user input (e.g., by pressing a button on user input device 56).

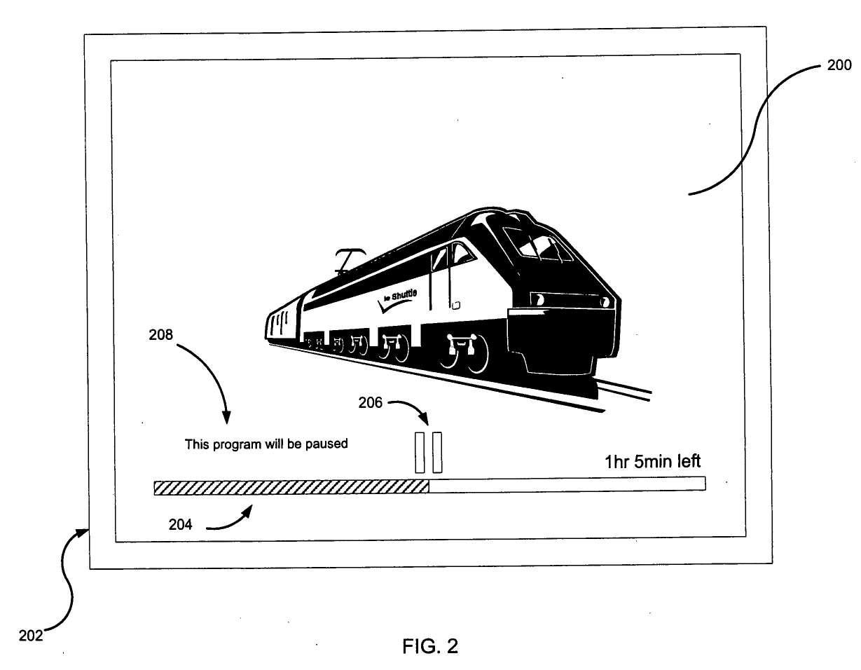

FIG. 2 is an exemplary screen display illustrating features of an embodiment. In the illustrated embodiment, a user (not shown) of the media system 30, is viewing a media program 200 on a display 202 of the presentation system 52. During the viewing of the media program 200, the user may decide to transition away from the program. For example, the user may wish to view and/or hear other content, such as a different media program or a menu interface, or the user may wish to deactivate (i.e., turn off) one or more components of the user equipment 40. Using the input device 56, for example, the user can issue an instruction (e.g., by pressing a “channel-up” or other button) to transition away from the media program 200.

In an embodiment, in response to the instruction, the program 200 is paused and a progress indicator 204, including, for example, a pause icon 206, is displayed overlaying the program to indicate that the program has been paused and the position at which the program has been paused. Also in response to the instruction, a textual informational message 208 is displayed serving to inform, and perhaps reassure, the user of one or more consequences of transitioning away from the program 200. For example, if, as in the illustrated example, the program 200 has been paused, the message 208 may inform the user that, upon transition away from the program, the program will remain paused. The progress indicator 204 and message 208 are displayed during an interstitial period of predetermined duration between issue of the instruction and transition away from the program 200. Alternatively, the program 200 is not paused in response to the instruction and continues to play during the interstitial period. In this latter case, the message 208 may inform the user that, upon transition away from the program 200, the program will be paused.

The message 208 may, of course, include any appropriate type of information serving to inform the user of one or more consequences of transitioning away from the program 200. For example, the message 208 may explicitly inform the user that he or she will be able to transition back to the media program 200 and resume viewing the media program from the displayed pause position. In an embodiment, the message 208 may further explicitly inform the user that the program 200 will be paused for a specified finite duration. For example, if the program 200 is provided to the user as on-demand or other limited-access content, the message 208 may specify the time at which access to and, thus, the ability to pause the program will cease. Alternatively, if, for example, constraints associated with one or more components of the system 30 will not allow the program 200 to be paused, the message 208 may explicitly inform the user that the program will not be paused.

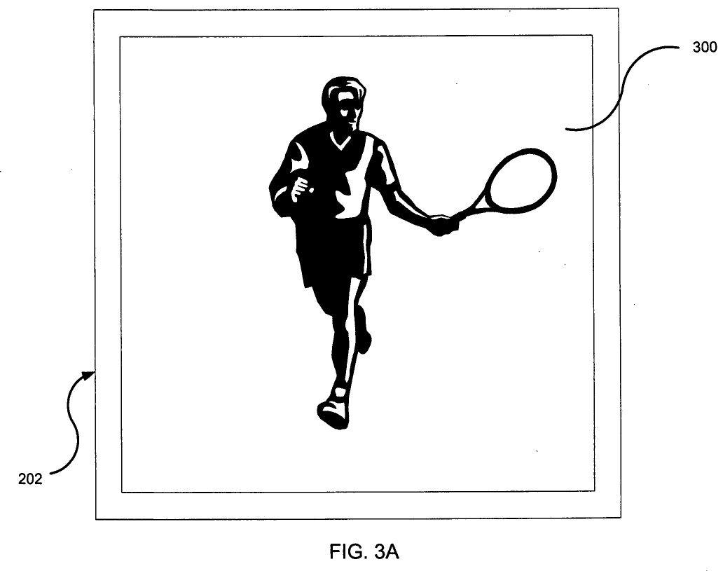

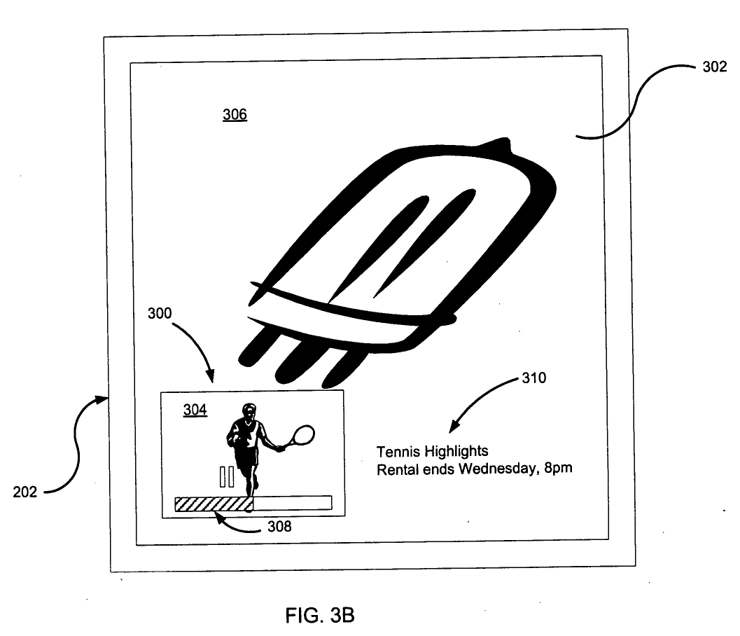

FIGS. 3A and 3B are exemplary screen displays illustrating features of an alternative embodiment of the present invention. In FIG. 3A, a user of the system 30 is viewing a media program 300 on the display 202. In a manner similar to that discussed above with reference to FIG. 2, during the viewing of the media program 300, the user may issue an instruction to present content 302 (FIG. 3B) different from the media program.

As illustrated in FIG. 3B, in response to the instruction, the program 300 is reduced in scale and displayed on a first portion 304 of the display 202. On the remainder, i.e., a second portion 306, of the display 202, the program 300 is supplanted by the content 302 requested by the user, thereby creating a conventional picture-in-picture (PIP) appearance. Alternatively, of course, the program 300 could occupy the second portion 306 and the requested content 302 could be scaled to occupy the first portion 304.

Additionally, the program 300 is paused and a progress indicator 308, including, for example, a pause icon, is displayed overlaying the program to indicate that the program has been paused and the position at which the program has been paused. Of course, if for some reason the program 300 fails to pause, the user is able to observe this failure by viewing the first portion 304. In addition, information pertaining to the program 300 may be displayed in a field 310 of the display 202. For example, if, as in the illustrated embodiment, the program 300 is accessible on a VOD basis, the information in the field 310 may inform the user of the time at which access to the program will expire. Accordingly, at the same time that the requested content 302 is viewable to the user, the reduced-scale view of the program 300, along with the progress indicator 308, serve to inform the user of the state of presentation and availability of the program. Consequently, the user is reassured that he or she will be able to transition back to a full-screen presentation of the media program 300 and resume viewing the media program from the displayed pause position.

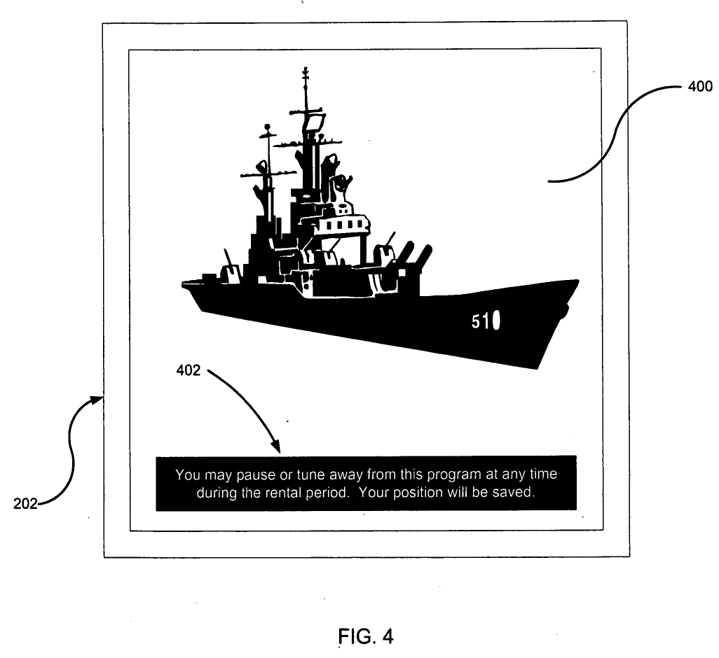

FIG. 4 is an exemplary screen display illustrating features of another alternative embodiment. In the illustrated embodiment, a user of the system 30, using, for example, the input device 56, selects an on-demand or other limited-access media program 400 for viewing on the display 202 of the presentation system 52. As the opening frames of the media program 400 are displayed, a message 402 is displayed overlaying the media program 400. The message 402 is displayed for a predetermined time duration and serves to inform the user of one or more consequences associated with certain actions (e.g., transitioning away from, pausing, etc.) that the user can take with respect to presentation of the program 400. In the illustrated embodiment, the message 402 informs the user that he or she can transition away from or pause the media program 400 and at a later time can transition back to the media program and/or resume viewing the media program from a pause position of the program.

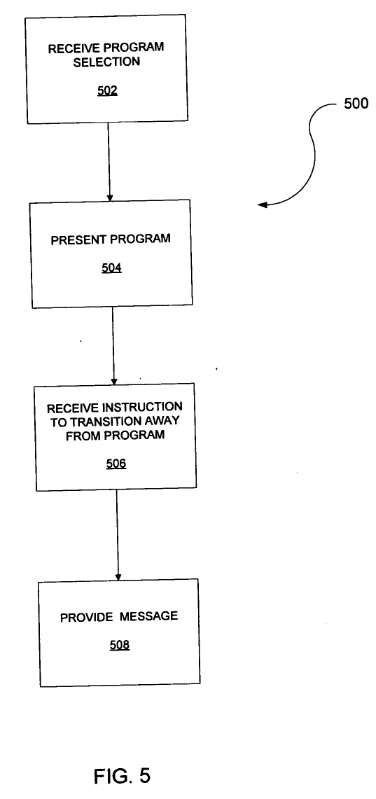

FIG. 5 illustrates a process 500 according to an embodiment. The process 500 is illustrated as a set of operations shown as discrete blocks. The process 500 may be implemented in any suitable hardware, software, firmware, or combination thereof. The operations need not be performed in the order shown.

The communications circuitry 48 receives 502 a media program selection from a user via a signal generated by the input device 56. Depending on the type and/or location of the selected program, this signal may be relayed or otherwise transmitted in appropriate form to the media distribution facility 36 and main facility 34 as a request to make the media program available to the user equipment 40.

The control circuitry 44 causes the selected media program to be presented 504 via the media presentation system 52. For example, the control circuitry 44 may enable presentation of media program content received by the communications circuitry 48 from the media distribution facility 36. Alternatively, the control circuitry 44 enables presentation of a program stored in the storage 46. If the program has video and audio components, such as may be the case with, for example, broadcast television or VOD, then the video components may be presented via the display 202, and the audio components may be presented via one or more audio speakers (not shown) associated with the media presentation system 52. If the program has solely a video component, such as may be the case with, for example, a digital photo album, then the program may be presented solely via the display 202. Similarly, if the program has solely an audio component, such as may be the case with, for example, an on-demand music or other audio selection, then the program may be presented solely via the one or more audio speakers associated with the media presentation system 52.

The control circuitry 44 receives 506 an instruction to transition away from the media program. The instruction may be received from the user by way of the communications circuitry 48. Alternatively, the instruction may be received from a recording-scheduler module (not shown) associated with the user equipment 40 or distribution facility 36. This latter case may result from the need to employ one or more currently occupied tuning assets associated with the communications circuitry 48 in order to record a different program.

The control circuitry 44, executing an interactive media application, provides 508 a message via the presentation system 52 that informs the user that the user can transition away from the program and that the user, at a later time, will be able to transition back to the media program and/or resume viewing the media program from a pause position of the program. As earlier discussed herein, this message may be provided via the display 202. Alternatively, the message may include or consist solely of an audio notification presented by an audio speaker associated with the media presentation system 52. Additionally, this message may be provided in response to receiving 502 the media program selection or receiving 506 the instruction.

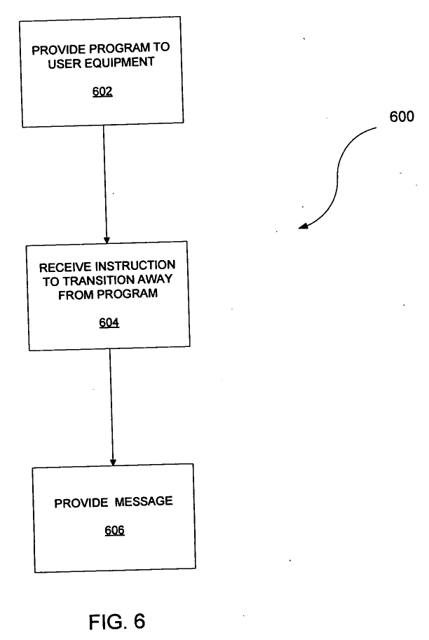

FIG. 6 illustrates a process 600 according to an embodiment. The process 600 is illustrated as a set of operations shown as discrete blocks. The process 600 may be implemented in any suitable hardware, software, firmware, or combination thereof. The operations need not be performed in the order shown.

One or more of the media distribution facility 36 and main facility 34 provides 602 a media program to the user equipment 40 for presentation via the presentation system 52.

The server 58 receives 604 a signal that the user equipment 40 is to transition away from the media program. For example, the instruction may be received by way of the communications circuitry 48 from the user or the recording-scheduler module associated with the user equipment 40. Alternatively, the instruction may be received from the recording-scheduler module associated with the distribution facility 36.

The distribution facility 36 provides 606 a signal to the user equipment 40 causing or enabling the presentation system 52 to inform the user that the program can be transitioned away from and that the user, at a later time, will be able to transition back to the media program and/or resume viewing the media program from a pause position of the program. For example, this signal may instruct the control circuitry 44 to execute an interactive media application to generate a message displayable on the display 202.

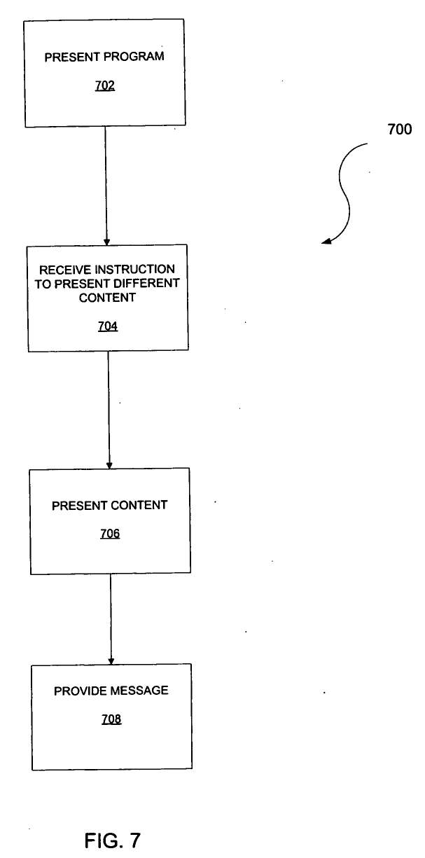

FIG. 7 illustrates a process 700 according to an embodiment of the invention. The process 700 is illustrated as a set of operations shown as discrete blocks. The process 700 may be implemented in any suitable hardware, software, firmware, or combination thereof. The operations need not be performed in the order shown.

The control circuitry 44 causes 702 a media program to be presented via the presentation system 52. In an embodiment, the media program comprises a displayable component. For example, if the media program is viewable, such as may be the case with, for example, broadcast television or VOD, then the displayable component may include the component of the program viewable on the display 202. Additionally, programs having an audio component and desirable primarily for their audio qualities, such as, for example, an on-demand music or other audio selection, may also include a component displayable on the display 202 as, for example, information or graphics (e.g., song title) describing or otherwise pertaining to the audio component.

The control circuitry 44 704 receives an instruction to present media content different from the media program. This content may be a media program or an interface item, such as a menu or the like.

The control circuitry 44 causes 706 the content to be presented via the presentation system 52. In an embodiment, and in a manner similar to that of the media program, the content includes a displayable component. Accordingly, presentation of the media content may include displaying the displayable component of the content on a portion of the display 202.

The control circuitry 44 provides 708 a message via the presentation system 52 that informs the user of the status of the media program presentation. For example, the message may inform the user that the program has been paused and indicate the position at which the program has been paused (i.e., the message may include a progress indicator). This message is provided concurrently with the display of the displayable component of the content. In an embodiment, this message may be displayed overlaying the content or displayed on a portion of the display 202 not occupied by the displayable component of the content. Alternatively, the displayable component of the program may include this message and be displayed on a portion of the display 202 not occupied by the displayable component of the content. Alternatively still, the message may include or consist solely of an audio notification presented by an audio speaker associated with the media presentation system 52.

Embodiments discussed herein may be realized as computer-readable media for carrying or having computer-executable instructions or data structures stored thereon. Such computer-readable media can be any available media that is accessible by a general-purpose or special-purpose computer or other electronic device. By way of example, and not limitation, such computer-readable media can include physical storage media such as RAM, ROM, EEPROM, CD-ROM or other optical disk storage, magnetic disk storage or other magnetic storage devices, or any other medium that can carry or store program code means. When information is transferred or provided over a network or another communications connection (either hardwired, wireless, or a combination of hardwired or wireless) to an electronic device, the electronic device properly views the connection as a computer-readable medium. Thus, such a connection is also properly termed a computer-readable medium. Consequently, combinations of the above should also be included within the scope of computer-readable media.

The preceding discussion is presented to enable a person skilled in the art to make and use the embodiments discussed herein. Various modifications to the disclosed embodiments will be readily apparent to those skilled in the art, and the generic principles herein may be applied to other embodiments and applications without departing from the spirit and scope of the present invention. Thus, the invention as claimed below is not intended to be limited to the embodiments shown, but is to be accorded the widest scope consistent with the principles and features disclosed herein.

What is claimed is:

1. A method in a system coupled with a presentation device, the method comprising:
receiving a selection of a media program for presentation to a user of the system; and
providing an audio or visual indication operable to be presented by the presentation device, the audio or visual indication indicating that transitioning away from presentation of the media program will pause the program, and/or the audio or visual indication indicating that transitioning to presentation of the media program will unpause the media program.

2. The method of claim 1, further comprising receiving an instruction to transition away from the media program, and in response presenting an indication of pausing the media program.

3. The method of claim 2 wherein the instruction is generated by the system.

4. The method of claim 2 wherein the audio or visual indication is provided in response to receiving the instruction.

5. The method of claim 1 wherein the media program comprises an on-demand game program, or an on-demand video program, or an on-demand audio program.

6. The method of claim 1 wherein transitioning away comprises transitioning to presentation of a displayable menu.

7. The method of claim 1 wherein the audio or visual indication indicates that transitioning to presentation of the media program will unpause the media program.

8. The method of claim 1 wherein the audio or visual indication comprises a visual indication comprising text.

9. The method of claim 1 wherein the presentation device comprises a display device.

10. The method of claim 1 wherein the media program is presented via the presentation device.

11. A computer-readable medium having stored therein executable instructions operable to cause the system to perform the method of claim 1.

12. A system operably coupleable with a display device comprising a display with which video programming can be displayed, the system being configured to perform a process comprising:
presenting with the display device an on-demand media program to a user of the system;
while presenting the on-demand media program, receiving an instruction to present content other than the on-demand media program;
presenting the content with the display device; and
presenting with the display device, concurrently with presenting the content, an indication of a presentation status of the on-demand media program.

13. The system according to claim 12, wherein the on-demand media program comprises a first displayable component, and wherein presenting the indication of pausing comprises displaying the first displayable component on a first portion of the display.

14. The system of claim 13 wherein the content comprises a second displayable component, and wherein presenting the content comprises displaying the second displayable component on a second portion of the display.

15. The system of claim 12 wherein the instruction is received from the user.

16. The system of claim 12 wherein the on-demand media program comprises an interactive game.

17. The system of claim 12 wherein the instruction comprises an instruction to transition to a program stored in a memory.

18. The system of claim 12 wherein the indication comprises a displayable icon.

19. The system of claim 12 wherein the presentation status comprises a pause status and the indication indicates that the on-demand media program has been paused.

20. A method performed in a system that includes a content distribution facility coupled with at least one client device for presenting on-demand programming via a presentation device, the method comprising:
transmitting a program from the content distribution facility to the client device; and
transmitting to the client device from the content distribution facility a signal operable to enable the client device to, via the presentation device, inform a user of the client device that transitioning away from presentation of the program will pause the program, and/or to inform the user of the client device that transitioning to the program, after having transitioned away from the program, will un-pause the program.
